(19) United States
(12) Patent Application Publication
(10) Pub. No.: US 2018/0113541 A1
(43) Pub. Date: Apr. 26, 2018

(54) ARRAY SUBSTRATE AND TOUCH DISPLAY DEVICE

(71) Applicant: Wuhan China Star Optoelectronics Technology Co., Ltd., Wuhan (CN)

(72) Inventors: JIANXING XIE, Wuhan (CN); Yao Li HUANG, Wuhan (CN); Chun Hung HUNAG, Wuhan (CN)

(73) Assignee: Wuhan China Star Optoelectronics Technology Co., Ltd., Wuhan (CN)

(21) Appl. No.: 14/897,666

(22) PCT Filed: Jul. 27, 2015
(86) PCT No.: PCT/CN2015/085195

§ 371 Date: Sep. 12, 2017

(30) Foreign Application Priority Data
May 11, 2015 (CN) 201510236147.5

(51) Int. Cl. G06F 3/041; G02F 1/1333; G02F 1/1343; G02F 1/1362

(52) U.S. Cl. CPC G06F 3/0412; G02F 1/13338; G09G 2310/0264; G02F 1/136286; G02F 1/1343

(57) ABSTRACT

Disclosed is an array substrate and touch display device which belongs to the technical field of display, and by means of which light leakage technical problem of the existing touch display devices can be solved. The array substrate comprises a sub-pixel unit array formed by a plurality of gate lines and a plurality of data lines, and further comprises a plurality of common electrodes. A gap is provided between two neighboring common electrodes. A shield line is provided at a location corresponding to the gap. When an image is displayed, the shield line has a same electric potential as the common electrode. The array substrate and touch display device provided by the present discourse can be used for mobile phones, tablet PCs, etc.

### CROSS-REFERENCE TO RELATED APPLICATIONS

The present application claims the priority of Chinese patent application CN201510236147.5, entitled “Array substrate and touch display device” and filed on May 11, 2015, the entirety of which is incorporated herein by reference.

### TECHNICAL FIELD

The present disclosure relates to the technical field of display, and in particular, to an array substrate and touch display device.

### TECHNICAL BACKGROUND

With the development of display technologies, liquid crystal display devices have become the most common display devices.

In the meanwhile, with the popularization of smart electronic products, capacitive touch screens are also widely used in electronic products, such as cell phones, tablet PCs, etc. Currently, capacitive touch screens mainly use one glass solution (OGS), on-cell, and in-cell technologies. Compared with OGS and on-cell technologies, in-cell technology is superior in production process, and products using it are thinner, lighter, and more transparent.

However, the existing technologies have at least the following technical problems. In current in-cell technologies, a common electrode has to be cut and divided into a plurality of common electrodes. As shown in FIGS. 1 and 2, the in-cell touch display device comprises a plurality of common electrodes 1 formed by cutting a common electrode, and a plurality of address lines 2, each of the common electrodes 1 being connected to a driving circuit 3 with an address line 2. When an image is displayed, the common electrode 1 is connected to a common voltage output end in the drive circuit 3 through the address line 2, and when touch scan is performed, the common electrode 1 is connected to a touch signal processor in the drive circuit 3 through the address line 2. But when a data line 4 transmits signal, an electrical field generated by the data line will go through a gap between the common electrodes 1 and consequently interfere with rotating directions of liquid crystals 5 near the gap, thereby leading to light leakage near the gap.

### SUMMARY OF THE INVENTION

The objective of the present disclosure is to provide an array substrate and a touch display device so that light leakage technical problem of existing technologies can be solved.

The present disclosure provides an array substrate which comprises a sub-pixel unit array formed by a plurality of gate lines and a plurality of data lines, and further comprises a plurality of common electrodes. A gap is provided between two neighboring common electrodes. A shield line is provided at a location corresponding to the gap. When an image is displayed, the shield line has a same electric potential as the common electrode.

Preferably, some of the data lines are located right below the shield line.

Further, the array substrate further comprises a plurality of address lines. Each of the common electrodes is connected to a drive circuit with one address line.

Preferably, the shield lines and the address lines may be located at a same layer.

Preferably, the address lines are made of a metallic material or a transparent conductive material.

Further, each of the sub-pixel units is provided therein with a thin film transistor and a pixel electrode.

Preferably, the shield lines and the pixel electrodes may be located at a same layer.

Preferably, the pixel electrode is located right above the common electrode.

The present disclosure further provides a touch display device which comprises a color filter substrate and the above mentioned array substrate.

Further, when an image is displayed, the common electrode is connected to a common voltage output end in the drive circuit through the address line, and when touch scan is performed, the common electrode is connected to a touch signal processor in the drive circuit through the address line.

The present disclosure is able to achieve the following beneficial effects. According to the technical solution provided by the present disclosure, the shield line is provided at a location corresponding to the gap between the common electrodes, and the shield line has a same electric potential as the common electrode. When the data line transmits signal, the shield line can shield the electrical field generated by the data line, thus avoiding effects on rotations of liquid crystals by the electrical field through the gap, thereby solving the light leakage problem of the existing touch display devices.

Other features and advantages of the present disclosure will be further explained in the following description, and will partly become self-evident therefrom, or be understood through the implementation of the present disclosure. The objectives and advantages of the present disclosure will be achieved through the structures specifically pointed out in the description, claims, and the accompanying drawings.

### BRIEF DESCRIPTION OF THE DRAWINGS

For further illustrating the technical solutions provided in the embodiments of the present disclosure, a brief introduction will be given below to the accompanying drawings involved in the embodiments.

FIG. 1 schematically shows a touch display device according to the existing technologies;

FIG. 2 is a sectional view of the touch display device along line A-A in FIG. 1;

FIG. 3 schematically shows a touch display device according to embodiment 1 of the present disclosure; and

FIG. 4 schematically shows a touch display device according to embodiment 2 of the present disclosure.

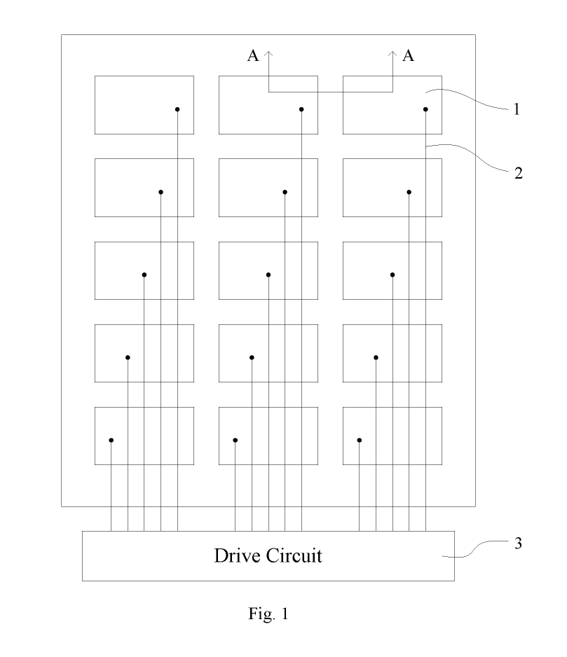

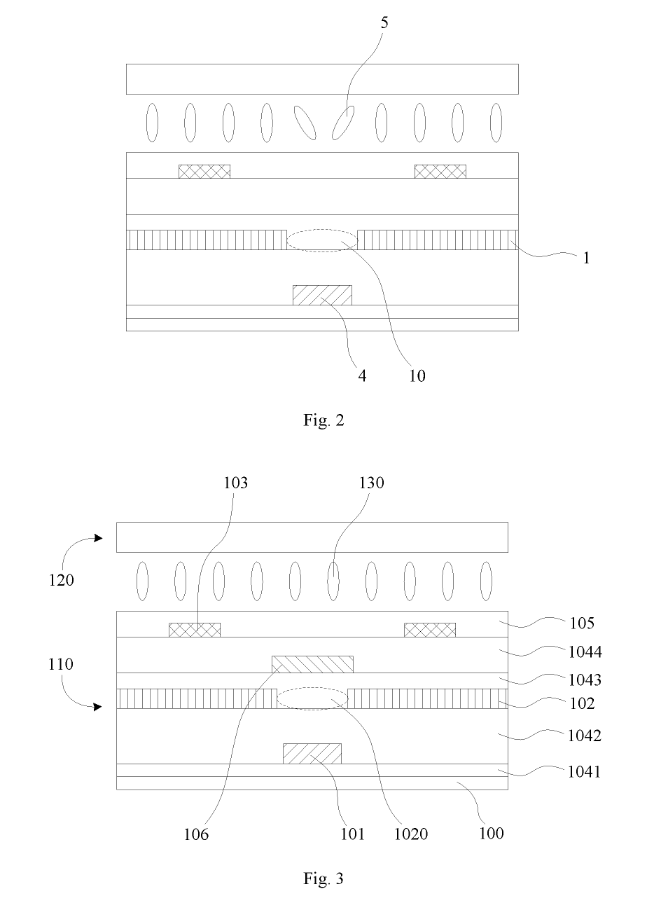

### DETAILED DESCRIPTION OF THE EMBODIMENTS

The present disclosure will be explained in detail below with reference to the embodiments and the accompanying drawings, so that one can fully understand how the present disclosure solves the technical problem and achieves the technical effects through the technical means, thereby implementing the same. It should be noted that as long as there is no structural conflict, any of the embodiments and any of the technical features thereof may be combined with one another, and the technical solutions obtained therefrom all fall within the scope of the present disclosure.

### Embodiment 1

The present embodiment provides a touch display device, which can be used as the touch display device for electrical products, such as mobile phones and tablet PCs, which adopt in-cell technology. As shown in FIG. 3, the touch display device comprises an array substrate 110, a color filter substrate 120, liquid crystals 130, a drive circuit (not shown in the Fig.), etc.

The array substrate 110 comprises, from bottom to top, a base substrate 100, a first metal layer, a first insulating layer 1041, a second metal layer, a second insulating layer 1042, a first transparent electrode layer, a third insulating layer 1043, a third metal layer, a fourth insulating layer 1044, a second transparent electrode layer, an alignment layer 105, etc., in turn. The array substrate specifically comprises a sub-pixel unit array formed by a plurality of gate lines (not shown in the Fig.) and a plurality of data lines 101, and also a plurality of common electrodes 102. The gate lines are located in the first metal layer. The data lines 101 are located in the second metal layer. The common electrodes 102 are located in the first transparent electrode layer.

Each of the sub-pixel units is provided therein with a thin film transistor (not shown in the Fig.) and a pixel electrode 103. The pixel electrode 103 is located above the common electrode 102. In the present embodiment, the array substrate 110 further comprises a plurality of address lines (not shown in the Fig.). Each of the common electrodes 102 is connected to the drive circuit with one address line. The pixel electrode 103 is located in the second transparent electrode layer, and the address lines are located in the third metal layer.

When an image is displayed, the common electrode 102 is connected to a common voltage output end in the drive circuit through the address line, forming an electrical field between the common electrode 102 and the pixel electrode 103, and thus enabling the liquid crystals 130 to rotate. When touch scan is performed, the common electrode 102 is connected to a touch signal processor in the drive circuit with the address line, so as to receive touch signal.

In the present embodiment, a gap 1020 is provided between two neighboring common electrodes 102, and a shield line 106 is provided at a location corresponding to the gap 1020. When an image is displayed, the shield line 106 has a same electric potential as the common electrode 102, for shielding an electrical field generated during transmission of signal by the data line 101. Since position of the gap between two common electrodes usually corresponds to position of the data line 101, by providing the shield line 106 at the location corresponding to the gap 1020, a corresponding data line 101 will be located right below the shield line 106, whereby a better shielding effect can be achieved.

When the touch scan is performed, the data line 101 does not transmit signal, and therefore, rotations of the liquid crystals 130 will not be affected. Thus, when the touch scan is performed, the shield line 106 can have a ground potential or an electric potential same as the common electrode 102.

In the touch display device provided by the present embodiment, the shield line 106 is provided at the location corresponding to the gap between the common electrodes 102, and the shield line 106 and the common electrode have the same electric potential. When the data line 101 transmits signal, the shield line 106 can shield the electrical field generated by the data line 101, thus avoiding effects on rotations of the liquid crystals 130 by the electrical field through the gap 1020, thereby solving the light leakage problem of the existing touch display devices.

As a preferred solution, in the present embodiment, the shield line 106 can be located in a same layer as the address lines. That is, both the shield line 106 and the address lines can be located at the third metal layer. In this case, in the process of manufacturing the array substrate, the shield line 106 and the address lines can be formed in a same photo engraving process, and it will be unnecessary to form the shield line 106 in a separate photo engraving process.

In the present embodiment, the shield lines 106 and the address lines are all made of metallic material. In other embodiments of the present disclosure, the shield lines 106 or the address lines can be made of a transparent conductive material such as Indium Tin Oxide (ITO).

### Embodiment 2

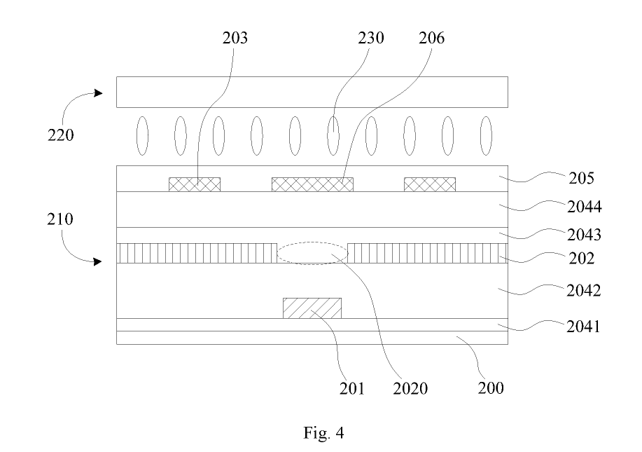

The present embodiment provides a touch display device, which can be used as the touch display device for electrical products, such as mobile phones and tablet PCs, which adopt in-cell technology. As shown in FIG. 4, the touch display device comprises an array substrate 210, a color filter substrate 220, liquid crystals 230, a drive circuit (not shown in the Fig.), etc.

The array substrate 210 comprises, from bottom to top, a base substrate 200, a first metal layer, a first insulating layer 2041, a second metal layer, a second insulating layer 2042, a first transparent electrode layer, a third insulating layer 2043, a third metal layer, a fourth insulating layer 2044, a second transparent electrode layer, an alignment layer 205, etc., in turn. The array substrate specifically comprises a sub-pixel unit array formed by a plurality of gate lines (not shown in the Fig.) and a plurality of data lines 201, and also a plurality of common electrodes 202. The gate lines are located at the first metal layer. The data lines 201 are located in the second metal layer. The common electrodes 202 are located in the first transparent electrode layer.

Each of the sub-pixel units is provided therein with a thin film transistor (not shown in the Fig.) and a pixel electrode 203. The pixel electrode 203 is located above the common electrode 202. In the present embodiment, the array substrate 210 further comprises a plurality of address lines (not shown in the Fig.). Each of the common electrodes 202 is connected to a drive circuit with one address line. The pixel electrode 203 is located in the second transparent electrode layer, and the address lines are located in the third metal layer.

When an image is displayed, the common electrode 202 is connected to a common voltage output end in the drive circuit through the address line, forming an electrical field between the common electrode 202 and the pixel electrode 203, and thus enabling the liquid crystals 230 to rotate. When touch scan is performed, the common electrode 202 is connected to a touch signal processor in the drive circuit through the address line, so as to receive touch signal.

In the present embodiment, a gap 2020 is provided between two neighboring common electrodes 202, and a shield line 206 is provided at a location corresponding to the gap 2020. When an image is displayed, the shield line 206 has a same electric potential as the common electrode 202, for shielding an electrical field generated during transmission of signal by the data line 201. Since position of the gap between two common electrodes 202 usually corresponds to the position of the data line 201, by providing the shield line 206 at the location corresponding to the gap 2020, a corresponding data line 201 will be located right below the shield line 206, whereby a better shielding effect can be achieved.

When the touch scan is performed, the data line 201 does not transmit signal, and therefore, rotations of the liquid crystals 230 will not be affected. Thus, when the touch scan is performed, the shield line 206 can have a ground potential or an electric potential same as the common electrode 202.

In the touch display device provided by the present embodiment, the shield line 206 is provided at the location corresponding to the gap between the common electrodes 202, and the shield line 206 and the common electrode have the same electric potential. When the data line 201 transmits signal, the shield line 206 can shield the electrical field generated by the data line 201, thus avoiding effects on rotations of the liquid crystals 230 by the electrical field through the gap 2020, thereby solving the light leakage problem of the existing touch display devices.

As a preferred solution, in the present embodiment, the shield line 206 can be located in a same layer as the pixel electrode 203. That is, both the shield line 206 and the pixel electrode 203 can be located in the second transparent electrode layer. In this case, in the process of manufacturing the array substrate, the shield line 206 and the pixel electrode 203 can be formed in a same photo engraving process, and it will be unnecessary to form the shield line 206 in a separate photo engraving process.

The above embodiments are described only for better understanding, rather than restricting the present disclosure. Anyone skilled in the art can make amendments to the implementing forms or details without departing from the spirit and scope of the present disclosure. The scope of the present disclosure should still be subject to the scope defined in the claims.

1. An array substrate, comprising a sub-pixel unit array formed by a plurality of gate lines and a plurality of data lines, and further comprising a plurality of common electrodes, wherein a gap is provided between two neighboring common electrodes,
wherein a shield line is provided at a location corresponding to the gap, and
when an image is displayed, the shield line has a same electric potential as the common electrode.

2. The array substrate according to claim 1, wherein some of the data lines are located right below the shield line.

3. The array substrate according to claim 1, further comprising a plurality of address lines, wherein each of the common electrodes is connected to a drive circuit with one address line.

4. The array substrate according to claim 3, wherein the shield lines are located in a same layer as the address lines.

5. The array substrate according to claim 3, wherein the shield lines are made of metallic material or a transparent conductive material.

6. The array substrate according to claim 3, wherein each of the sub-pixel units is provided therein with a thin film transistor and a pixel electrode.

7. The array substrate according to claim 6, wherein the shield lines are located in a same layer as the pixel electrodes.

8. The array substrate according to claim 6, wherein the pixel electrode is located right above the common electrode.

9. A touch display device, comprising a color filter substrate and an array substrate,
wherein the array substrate comprises a sub-pixel unit array formed by a plurality of gate lines and a plurality of data lines, and further comprises a plurality of common electrodes, wherein a gap is provided between two neighboring common electrodes,
wherein a shield line is provided at a location corresponding to the gap, and
when an image is displayed, the shield line has a same electric potential as the common electrode.

10. The touch display device according to claim 9, wherein when an image is displayed, the common electrode is connected to a common voltage output end in a drive circuit through the address line, and
when touch scan is performed, the common electrode is connected to a touch signal processor in the drive circuit through the address line.
